(19) United States
(12) Patent Application Publication
(10) Pub. No.: US 2006/0164446 A1
(43) Pub. Date: Jul. 27, 2006

(54) Printhead inspection device usable with an inkjet printer and a method thereof

(76) Inventor: O-hyun Beak, Seoul (KR)

Correspondence Address: STANZIONE & KIM, LLP, 919 18TH STREET, N.W., SUITE 440, WASHINGTON, DC, 20006, US

(21) Appl. No.: 11/332,367

(22) Filed: Jan. 17, 2006

(30) Foreign Application Priority Data
Jan. 24, 2005 (KR) 2005-6384

(51) Int. Cl. B41J 29/38

(52) U.S. Cl. 347/5

(57) ABSTRACT

A printhead inspection device usable with an inkjet printer and a method thereof. In the printhead inspection device a printhead having a plurality of nozzle driving parts corresponds to a plurality of nozzles to eject ink through the plurality of nozzles, the printhead inspection device may include a current measurement part to measure driving current flowing in a load resistor between a power supply and the printhead having the plurality of nozzle driving parts, a calculation part to take one or more representative values from the respective driving current measured by the current measurement part, and a driving control part to generate signals to sequentially drive the plurality of nozzle driving parts and to determine a driving voltage or driving pulse width of the printhead based on the representative values taken by the calculation part.

### CROSS-REFERENCE TO RELATED APPLICATIONS

This application claims benefit under 35 U.S.C. § 119(a) of Korean Patent Application No. 2005-6384, filed Jan. 24, 2005, the entire contents of which are incorporated herein by reference.

### BACKGROUND OF THE INVENTION

1. Field of the Invention

The present general inventive concept relates to a printhead inspection device of an inkjet printer, and a method thereof. More particularly, the present general inventive concept relates to a printhead inspection device to eject ink through nozzles using thermal energy.

2. Description of the Related Art

A printer is regarded as an essential peripheral device for personal computer users. As such, a wide distribution of printers to users has created an emergence of low-priced inkjet printers.

The inkjet printer is generally constructed in such a manner that ink is ejected on paper through minute nozzles prepared at a printhead of the inkjet printer. There are various methods to eject ink through nozzles, and a method of heating nozzles of the printhead is most commonly used.

As illustrated in FIG. 1, the nozzle-heating type printhead is provided with a heating resistor or resistance R_{H} for heating nozzles, and a driving part M1 operating to supply a driving voltage (V_{f}) to the heating resistance R_{H} in response to an address input signal. The heating resistance R_{H} and the driving part M1 are collectively named as a nozzle driving part for convenience. FIG. 1 illustrates that the printhead has only one driving part M1 and one heating resistance R_{H}, but in a real structure, the printhead is provided with the M×N (M columns×N rows) number of nozzles with a matrix formed both horizontally and vertically, with the nozzle driving part arranged corresponding to each nozzle as illustrated in FIG. 1.

The unit dpi (dots per inch) is used as a measure of printer performance. A dpi refers to a numerical value for displaying a maximum number of dots that can be possibly placed in 1 inch, for example, 600 dpi is 600 dots in 1 inch (approximately 2.5 cm). A comparison of inkjet printers having between 360 dpi and 720 dpi shows clear differences in the density of dots.

In some cases, dots are not properly formed on prints because of a malfunction in the printhead or ink clogging in the nozzles. In this case, a user can confirm the print quality through spitting. It is possible to restore the printhead to its normal working condition through spitting, in case of a nozzle malfunction due to clogging with ink. However, ink is unnecessarily consumed in a case of a malfunction caused by a failure in a nozzle driving circuit.

An inkjet printer, which is capable of determining whether the malfunctions were caused due to the driving circuit of a printhead nozzle, was disclosed in Korean Patent Application No. 2002-8093 filed by the same assignee and registered to Korean Patent No. 10-0437377 on Jun. 15, 2004.

FIG. 2 is a block diagram schematically illustrating the inkjet printer capable of determining whether malfunctions are caused due to the driving circuit of the printhead nozzle, and FIG. 3 is a circuit diagram of the nozzle driving part 30 and a nozzle malfunction detection part 40 of FIG. 2.

Referring to the FIGS. 1 and 2, the conventional inkjet printer determining whether the malfunctions are caused due to the printhead nozzles, will now be explained. An input part 10 receives a command from a user to check for the presence of malfunctions of a plurality of nozzle driving parts 30, and a power supply 20 supplies a driving power to the nozzle driving parts 30 of the printhead.

The nozzle malfunction detection part 40 supplies a second driving power to the nozzle driving parts 30 and outputs normal or abnormal operation signals of the plurality of nozzle driving parts 30, according to voltage drop levels of the second driving power and according to driving the plurality of nozzle driving parts 30. A display 50 displays whether there are any malfunctions of the nozzle driving parts 30.

If a command to check for malfunctions of the plurality of nozzle driving parts 30 is input to the input part 10, a control part 60 blocks a first driving power which is supplied in normal operation of the nozzle driving parts 30, sequentially drives the plurality of nozzle driving parts 30 by the second driving power, and exhibits identifiers of problem-detected nozzle driving parts 30.

However, the inkjet printer is not designed to display current values associated with an actual driving of the nozzle driving part 30, but only the fact as to whether the heating resistance R_{H} and FET (Field Effect Transistor) of the nozzle driving part are electrically short-circuited. Thus differences between inter-headchip heating resistance and resistance upon the actual driving of the FET are impossible to obtain. Accordingly, to overcome this drawback, an extra amount of driving energy is supplied to the inkjet head. However, this causes problems such as an increase in power consumption and a decrease in a life span of the head chip.

### SUMMARY OF THE INVENTION

The present general inventive concept provides a printhead inspection device usable with an inkjet printer capable of measuring nozzle heating resistance of a printhead and resistance in driving a FET of a nozzle driving part, and measuring inter-head resistance deviation to drive print nozzles by using a reduced amount of input energy and a method thereof. The present general inventive concept may also provide a driving current measuring device usable with a printhead and a method thereof.

Additional aspects and advantages of the present general inventive concept will be set forth in part in the description which follows and, in part, will be obvious from the description, or may be learned by practice of the general inventive concept.

The foregoing and/or other aspects of the present general inventive concept may provide a printhead inspection device usable with an inkjet printer with a printhead having a plurality of nozzle driving parts corresponding to a plurality of nozzles to eject ink through the plurality of nozzles the printhead inspection device may include a current measurement part to measure a driving current flowing in a load resistor located between a power supply and the printhead having the plurality of nozzle driving parts, a calculation part to take one or more representative values from the respective driving current measured by the current measurement part, and a driving control part to generate signals to sequentially drive the plurality of nozzle driving parts and to determine a driving voltage or driving pulse width of the printhead based on the representative values taked by the calculation part.

The printhead inspection device may further include a storage part to store the representative values taken by the calculation part, where the driving control part reads out the representative values stored at the storage part before a printing execution by a printer of the corresponding printhead, and determines a driving voltage or driving pulse width of the printhead by use of a look up table pre-stored at the printer.

The printhead inspection device may further include an AD (analog-to-digital) converter to convert the driving current measured by the current measurement part and voltage drop measured by the load resistor to digital signals. The calculation part recognizes heating resistance characteristics of heating resistances of the printhead based on the digital signal converted by the AD converter.

The calculation part may take the representative values in consideration of ink ejection velocity with respect to energy supplied to the printhead.

The AD converter may use at least one clock having a frequency of approximately 5 to 10 MHz.

The current measurement part, the calculation part, the driving control part, the storage part and the AD converter may be embodied in one printhead chip.

The storage part may be embodied as a fuse ROM (Read-Only-Memory).

The foregoing and/or other aspects of the present general inventive concept may also be achieved by providing a printhead inspection method usable with an inkjet printer the printhead inspection method may include sequentially driving a plurality of nozzle driving parts corresponding to a plurality of nozzles provided at a printhead to eject ink though the plurality of nozzles, measuring driving current flowing in a load resistor between a power supply and the printhead having the plurality of sequentially-driven nozzle driving parts, taking one or more representative values from the respective driving currents as measured, and determining a driving voltage or a driving pulse width of the printhead based on the representative values taken.

The printhead inspection method may further include storing the representative value taken in a fuse ROM, and where determining the driving voltage or the driving pulse width of the printhead includes reading out the representative value stored at the fuse ROM before printing execution by the printer, and using a look-up table pre-stored at the printer to determine the driving voltage or the driving pulse width.

The printhead inspection method may further include converting into digital signals a driving current as measured, and a voltage drop of the load resistor, where the taking of the representative values includes recognizing heating resistance characteristics of the printhead based on the converted digital signals.

The taking of the representative values may include taking the representative values in consideration of ink ejection velocity.

The converting of the driving current and the voltage drop into digital signals may include using at least one clock having a frequency of approximately 5 to 10 MHz.

The foregoing and/or other aspects of the of the present general inventive concept may be achieved by providing a driving current measurement device usable with a printhead, the method including a printhead having a plurality of nozzle driving parts corresponding to a plurality of nozzles in order to eject ink through the plurality of nozzles, a load resistor located between a power supply and the printhead, and a control part to generate signals to drive the plurality of nozzle driving parts, and where the driving current flowing in the load resistor is measured with respect to the plurality of nozzle driving parts sequentially driven according to signals generated by the control part.

The driving current measurement device may further include an AD converter (analog-to-digital) to convert a driving current measured by the current measurement part and a voltage drop measured at the load resistor into digital signals, and a calculation part to recognize characteristics of heating resistance of the printhead based on the digital signals converted by the AD converter.

The foregoing and/or other aspects of the present general inventive concept may be achieved by providing a driving current measurement method usable with a printhead, the method including sequentially driving a plurality of nozzle driving parts corresponding to a plurality of nozzles of a printhead in order to eject ink through the plurality of nozzles, and measuring a driving current flowing through a load resistor located between a power supply and the printhead with respect to the plurality of sequentially driven nozzle driving parts.

The driving current measurement method may further include converting the driving current as measured, and a voltage drop at the load resistor into digital signals, and recognizing characteristics of heating resistance of the printhead based on the digital signals as converted.

The foregoing and/or other aspects of the present general inventive concept may be achieved by providing a printhead inspection device including a plurality of nozzle driving parts to drive respective nozzles to eject ink, each of the nozzle driving parts having at least one transistor that is driven by a current supplied by respective nozzle driving signals, and a nozzle decode/address logic to receive the nozzle driving signals and provide the nozzle driving signals to the respective nozzle driving parts to sequentially drive the nozzle driving parts, where the nozzle driving signals are based on one or more representative values that correspond to heating resistance characteristics of the printhead.

The foregoing and/or other aspects of the present general inventive concept may be achieved by providing a printhead driving current measuring device including a plurality of nozzle driving parts to drive respective nozzles to eject ink, each of the nozzle driving parts having at least one transistor that is driven by a current supplied by respective nozzle driving signals, a control part to measure driving currents of the corresponding nozzle driving signals supplied to the respective nozzle driving parts, and a nozzle decode/address logic to receive the nozzle driving signals and provide the nozzle driving signals to the respective nozzle driving parts to sequentially drive the nozzle driving parts, where the nozzle driving signals are based on one or more representative values that correspond to heating resistance characteristics of the printhead.

The foregoing and/or other aspects of the present general inventive concept may be achieved by providing a printhead inspection device including a current measuring part that measures driving currents at a load resistor between a power supply and a plurality of nozzle driving parts of a printhead, an AD converter that converts the driving currents and the corresponding voltage drop at the load resistor into digital signals, a calculation part to calculate voltages to be applied to the printhead based on the digital signals and to calculate one or more representative values based on the driving currents and in consideration of an ink ejection velocity, and a driving control part to generate signals to sequentially drive the plurality of nozzle driving parts and to determine a driving voltage or driving pulse width of the printhead based on the representative values calculated by the calculation part.

Accordingly, the printhead inspection device usable with an inkjet printer according to the present general inventive concept, is capable of not only measuring nozzle heating resistance of an inkjet printhead and resistance upon driving a FET, but also calculating the minimum energy necessary to drive the printhead by measuring resistance deflections between heads, to accordingly save input energy and increase printhead lifespan.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a circuit diagram illustrating a conventional nozzle driving part of an inkjet printer;

FIG. 2 is a block diagram illustrating a conventional inkjet printer;

FIG. 3 illustrates a detailed circuit diagram of a nozzle driving part 30 and a nozzle malfunction detection part 40 of FIG. 2;

FIG. 4 illustrates a printhead inspection device usable with an inkjet printer according to an embodiment of the present general inventive concept;

FIG. 5 illustrates a printhead inspection method usable with the inkjet printer of FIG. 4;

FIG. 6 is a graphical representation illustrating an example characteristic curve of heating resistance according to an embodiment of the present general inventive concept;

FIG. 7 is a graphical representation illustrating an example of driving current distribution according to an embodiment of the present general inventive concept;

FIG. 8 is a graphical representation illustrating a relationship of ink ejection velocity with respect to energy supplied to the printhead according to an embodiment of the present general inventive concept; and

FIG. 9 illustrates a driving current measuring device of the printhead according to an embodiment of the present general inventive concept.

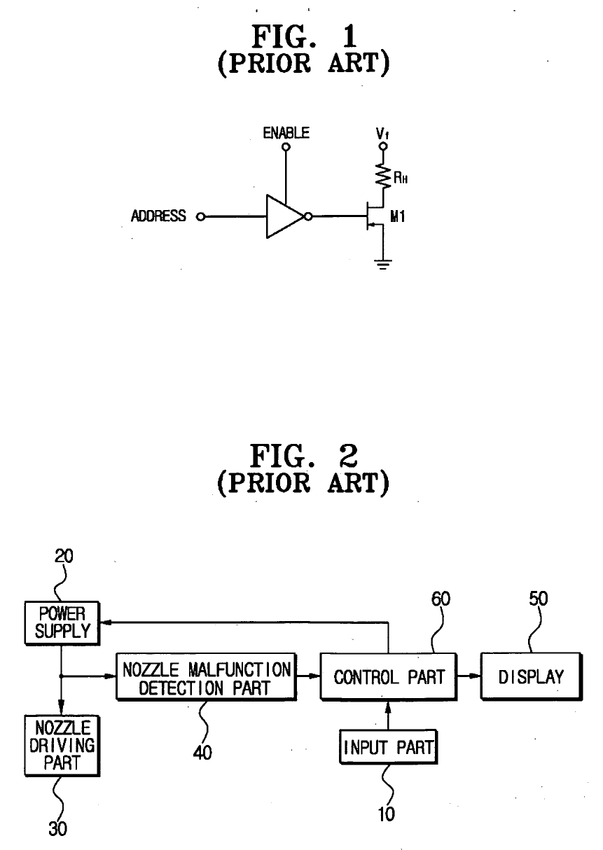

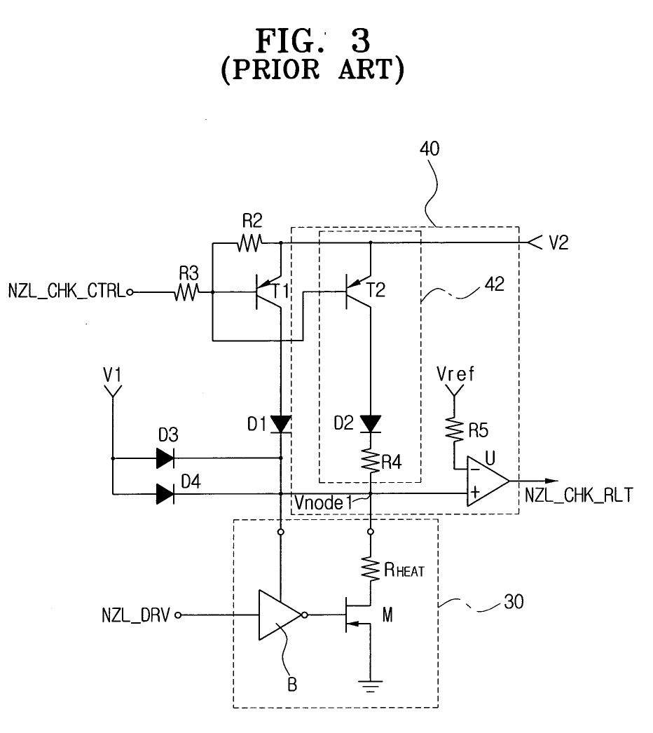

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

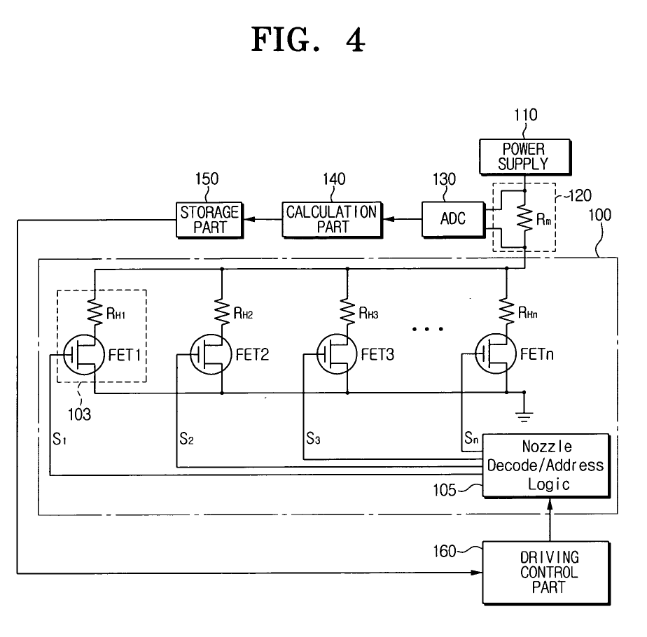

FIG. 4 is a view of a printhead inspection device usable with an inkjet printer, according to an embodiment of the present general inventive concept. Referring to FIG. 4, the printhead inspection device usable with an inkjet printer (not shown) includes a printhead 100, a power supply 110, a current measurement part 120, an AD converter (ADC) 130, a calculation part 140, a storage part 150 and a driving control part 160. The current measurement part 120, the AD converter 130, the calculation part 140, the storage part 150 and the driving control part 160 may be embodied in one printhead chip.

The printhead 100 includes a plurality of nozzle driving parts 103 having heating resistance values which may be represented by resistors or resistances R_{H1} to R_{Hn,} FETs (Field effect transistors) FET1 to FETn, and a nozzle decode/address logic 105 to control the nozzle driving signals input to the FETs of respective nozzle driving parts 103. The respective nozzle driving parts 103 are arranged in an order corresponding to a plurality of nozzles (not shown) to allow ink to be ejected through the plurality of nozzles. FIG. 4 illustrates that the plurality of nozzle driving parts 103 are in a horizontal arrangement, but one will understand that the nozzle driving parts 103 may be arranged, in a M×N (M columns×N rows) matrix form.

The power supply 110 supplies power to the nozzle driving parts 103 of the printhead 100.

The current measurement part 120 measures driving currents flowing in load resistor Rₘ between the printhead 100 and the power supply 110 with respect to the plurality of sequentially driven nozzle driving parts 103.

The AD converter 130 converts the driving currents measured by the current measurement part 120 and a voltage drop by the load resistor Rₘ into digital signals. The calculation part 140 recognizes heating resistance characteristics of the printhead 100 based on the converted digital signals by the AD converter 130. Also, the calculation part 140 takes representative values from the respective driving currents measured by the current measurement part 120.

The storage part 150 stores representative values taken by the calculation part 140. The storage part 150 may be embodied as ROM, such as Fuse ROM.

The driving control part 160 generates signals to sequentially drive the plurality of nozzle driving parts 103 and determines a driving voltage or driving pulse width of the printhead 100 based on the representative values taken by the calculation part 140. The driving control part 160 reads out the representative values stored at the storage part 150 prior to executing a printing operation by the printer, and determines a driving voltage or driving pulse width of the printhead 100 by use of a look up table (LUT) pre-stored at the printer.

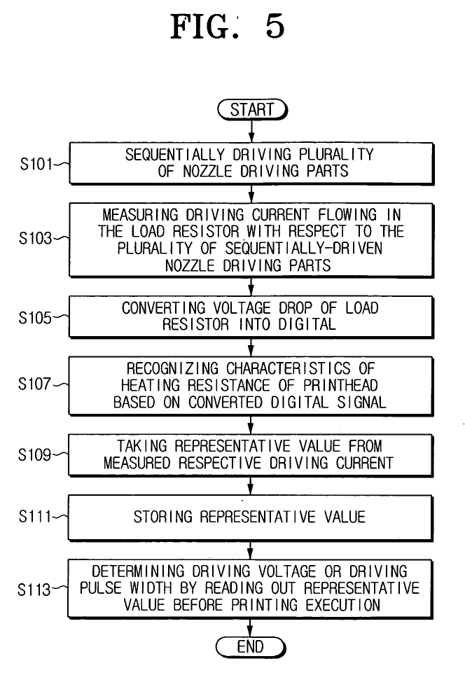

FIG. 5 is a flowchart illustrating a printhead inspection method of an inkjet printer according to the printhead inspecting device of FIG. 4.

If nozzle data generated to be used by the printer to print is output from a CPU (not shown), nozzle data signals output from the CPU are converted into individual nozzle signals S1 to Sn by the nozzle decode/address logic 105 of the printhead 100, and supplied to a gate of one or more of the FETs (FET1-FETn) of the corresponding nozzles. The individual nozzle signals S1 to Sn cause currents to flow that heat the heating resistances R_{H1} to R_{Hn}. The current values are determined by values of the heating resistances R_{H1} to R_{Hn}, and the voltage supplied from the power supply 110, which is a predetermined voltage value of the printer.

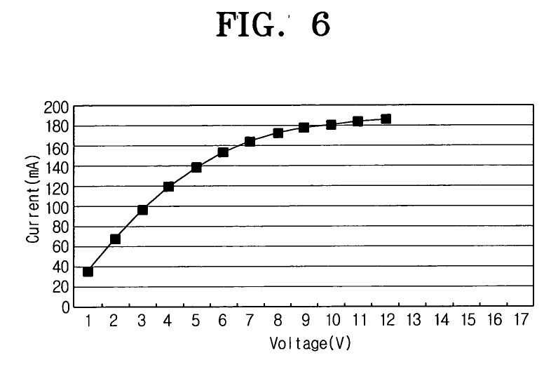

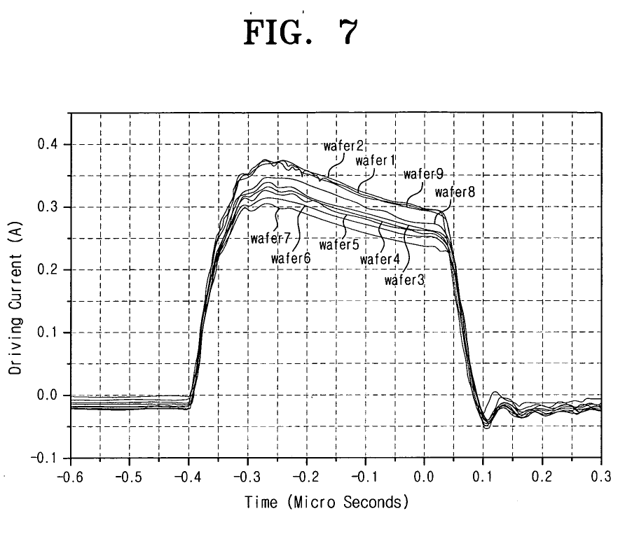

The value of the heating resistances R_{H1} to R_{Hn} is determined by a thin film heater formed during a semiconductor manufacture process of printhead chips. The thin film heaters have different values depending on wafers or locations of the printhead chips in the wafers. Accordingly, the heating resistances R_{H1} to R_{Hn} of respective printhead chips are measured, respectively, and the driving voltage or the driving time is adjusted accordingly during the driving of the nozzle driving parts 103. However, as illustrated in FIG. 6, the heating resistances R_{H1} to R_{H1} have non-linear characteristics, which causes differences in the heating resistances R_{H1} to R_{H1} between a usual measurement of resistance values at a low-voltage, i.e., 1˜9 volts and a measurement of resistance values at a high voltage, i.e., 10˜15 volts, which may be used as the value of the actual driving voltages. In order to know differences between nominal resistance values and resistance values used in an actual driving circuit, the non-linear characteristics of the heating resistances R_{H1} to R_{Hn} should be considered.

In the inspection process of the printhead 100 illustrated in FIG. 5, the driving control part 160 generates signals to sequentially drive the plurality of nozzle driving parts 103, so that ink is ejected through the plurality of nozzles provided at the printhead 100, at operation S101.

When the plurality of nozzle driving parts 103 are sequentially driven by the driving control part 160, the current measurement part 120 measures the driving currents flowing in the load resistor Rₘ between the printhead 100 and the power supply 110, at operation S103. The power supply 110 can supply power to the printhead 100 through a single line to sequentially drive the plurality of nozzle driving parts 103, and it is possible to measure the driving currents supplied to the respective nozzle driving parts 103 inside the printhead 100. FIG. 7 illustrates examples of the driving currents measured from nine different wafers, respectively, and illustrates differences between the respective driving currents. Such phenomena are caused due to the non-linear characteristics of the heating resistances R_{H1} to R_{Hn}, which usually does not appear in nominal resistance values.

In order to recognize the non-linear characteristics of the heating resistances R_{H1} to R_{Hn}, the AD converter 130 converts the driving currents measured by the current measurement part 120 and voltage drops by the load resistor Rₘ into digital signals at operation S105. Since it usually takes approximately 1 μs of time for currents to be supplied to the heating resistances R_{H1} to R_{Hn}, the AD converter 130 can perform the digitized conversion by using at least one clock having a frequency of 5 to 10 MHz at the printhead 100.

The calculation part 140 recognizes the characteristics of the heating resistances R_{H1} to R_{Hn} of the printhead 100 based on digital signals converted by the AD converter 130, at operation S107. That is, the calculation part 140 calculates voltages substantially supplied to the printhead 100 based on digital signals converted by the AD converter 130. Therefore, the resistance values of the heating resistances R_{H1} to R_{Hn} can be accurately determined based on the calculated voltages and the measured driving currents.

Also, the calculation part 140 takes or calculates representative values from respective driving currents measured by the current measurement part 120, at operation S109. That is, the calculation part 140 takes representative values with respect to the driving currents measured at several wafers, i.e. nine wafers, as illustrated in FIG. 7. Here, the calculation part 140 takes the representative values in consideration of ink ejection velocity supplied to the printhead 100.

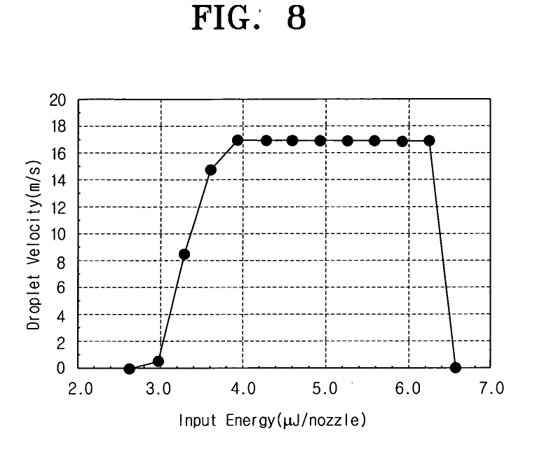

Heater performance can be demonstrated by a relationship between the driving energy of the printhead 100 and the ink ejection velocity, and based on a critical value, as illustrated in FIG. 8. Accordingly, once the ejection velocity is saturated, for example, with respect to FIG. 8, at approximately 17 m/s, the performance of the heater is maintained at this constant velocity value and does not change even with more energy supplied thereafter. Also, since an energy oversupply causes heater degradation, the calculation part 140 takes a threshold current value corresponding to the critical value of the ejection velocity and stores the threshold current value and/or the critical value as the representative values.

The storage part 150 stores the representative values taken by the calculation part 140, at operation S111. The driving control part 160 reads out the representative values pre-stored at the storage part 150 before printing execution by the printer, and compares the relationship between the representative values and the driving voltage or the driving pulse width and uses a look-up table pre-stored at the printer to determine the driving voltage or the driving pulse width of the printhead based on the relationship, at operation S113.

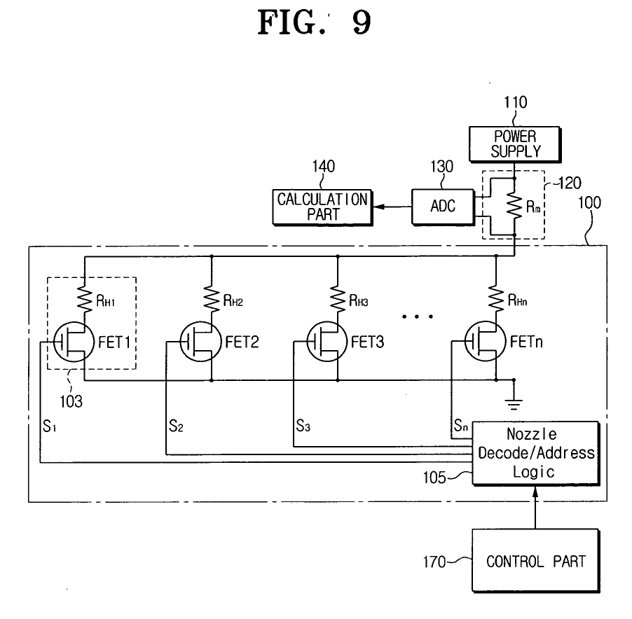

FIG. 9 is a view of a driving current measuring device usable with a printhead according to another embodiment of the present general inventive concept. Referring to FIG. 9, the driving current measuring device has a printhead 100, a power supply 110, a load resistor Rₘ, an AD converter 130, a calculation part 140, and a control part 170. Here, since the elements defined in the aforementioned description of FIG. 4 such as the printhead 100, the power supply 110, the load resistor Rₘ, the AD converter 130, and the calculation part 140, refer to the same drawing reference numerals in FIG. 9, any further detailed description of those elements will be omitted.

Referring to FIG. 9, the control part 170 sequentially drives the plurality of nozzle driving parts 103 so that ink is ejected through the plurality of nozzles prepared at the printhead 100. With a measurement of currents flowing in load resistor Rₘ with respect to sequential driving of the plurality of nozzle driving parts 103, it is possible to measure the driving currents of the corresponding driving signal S1 to Sn supplied to respective nozzle driving parts 103.

The AD converter 130 uses the load resistor Rₘ and converts the voltage drops and the driving currents into digital signals, and the calculation part 140 recognizes the heating resistance characteristics of the printhead 100 based on the converted digital signals.

As described in a few exemplary embodiments of the present general inventive concept, the printhead inspection device usable with an inkjet printer confirms the driving status of respective nozzles of each print head and measures accurate currents within the corresponding printhead chips or between the printhead chips and therefore, is able to utilize optimum driving requirements.

The printhead inspection device usable with an inkjet printer enables a sufficiently wide range of resistance specifications and margins through optimum driving thereof.

Additionally, the printhead inspection device usable with an inkjet printer performs ink ejection, while conserving energy and reducing heater degradation caused by an oversupply of energy.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A printhead inspection device usable with an inkjet printer with a printhead having a plurality of nozzle driving parts corresponding to a plurality of nozzles to eject ink through the plurality of nozzles, the printhead inspection device comprising:
a current measurement part to measure a driving current flowing in a load resistor between a power supply and the printhead having the plurality of nozzle driving parts;
a calculation part to take one or more representative values from the respective driving current measured by the current measurement part; and
a driving control part to generate signals to sequentially drive the plurality of nozzle driving parts and to determine a driving voltage or driving pulse width of the printhead based on the representative values taken by the calculation part.

2. The printhead inspection device as claimed in claim 1, further comprising:
a storage part to store the representative values taken by the calculation part,
wherein the driving control part reads out the representative values stored at the storage part before a printing execution by a printer of the corresponding printhead, and determines a driving voltage or a driving pulse width of the printhead by use of a look-up table pre-stored at the printer.

3. The printhead inspection device as claimed in claim 2, further comprising:
an AD (analog-to-digital) converter to convert the driving current measured by the current measurement part and voltage drop measured by the load resistor to digital signals,
wherein the calculation part recognizes heating resistance characteristics of heating resistances of the printhead based on the digital signal converted by the AD converter.

4. The printhead inspection device as claimed in claim 3, wherein the calculation part takes the representative values in consideration of ink ejection velocity with respect to energy supplied to the printhead.

5. The printhead inspection device as claimed in claim 3, wherein the AD converter uses at least one clock having a frequency of approximately 5 to 10 MHz.

6. The printhead inspection device as claimed in claim 3, wherein the current measurement part, the calculation part, the driving control part, the storage part, and the AD converter are embodied in one printhead chip.

7. The printhead inspection device as claimed in claim 3, wherein the storage part is embodied as a fuse ROM (Read-Only-Memory).

8. A printhead inspection method usable with an inkjet printer comprising:
sequentially driving a plurality of nozzle driving parts corresponding to a plurality of nozzles provided at a printhead to eject ink through the plurality of nozzles;
measuring driving currents flowing in a load resistor between a power supply and the printhead having the plurality of sequentially-driven nozzle driving parts;
taking one or more representative values from the respective driving currents as measured; and
determining a driving voltage or a driving pulse width of the printhead based on the representative values taken.

9. The printhead inspection method as claimed in claim 8, further comprising:
storing the representative value taken in a fuse ROM,
wherein determining the driving voltage or the driving pulse width of the printhead includes reading out the representative value stored at the fuse ROM before printing execution by the printer, and using a look-up table pre-stored at the printer to determine the driving voltage or the driving pulse width.

10. The printhead inspection method as claimed in claim 9, further comprising:
converting into digital signals a driving current as measured, and a voltage drop of the load resistor,
wherein the taking of the representative values includes recognizing heating resistance characteristics of the printhead based on the converted digital signals.

11. The printhead inspection method as claimed in claim 10, wherein the taking of the representative value includes taking the representative value in consideration of ink ejection velocity with respect to energy supplied to the printhead.

12. The printhead inspection method as claimed in claim 10, wherein the converting of the driving current and the voltage drop into digital signals includes using at least one clock having a frequency of approximately 5 to 10 MHz.

13. A driving current measurement device usable with a printhead comprising:
a printhead having a plurality of nozzle driving parts corresponding to a plurality of nozzles in order to eject ink through the plurality of nozzles;
a load resistor located between a power supply and the printhead; and
a control part to generate signals to drive the plurality of nozzle driving parts,
wherein a driving current flowing in the load resistor is measured with respect to the plurality of nozzle driving parts sequentially driven according to signals generated by the control part.

14. The driving current measurement device as claimed in claim 13, further comprising:
an AD (analog-to-digital) converter to convert a driving current measured by the current measurement part and a voltage drop measured at the load resistor into digital signals; and
a calculation part to recognize characteristics of heating resistances of the printhead based on the digital signals converted by the AD converter.

15. The driving current measurement device as claimed in claim 14, wherein the AD converter uses at least one clock having a frequency of approximately 5 to 10 MHz.

16. A driving current measurement method usable with a printhead, the method comprising:
sequentially driving a plurality of nozzle driving parts corresponding to a plurality of nozzles of a printhead in order to eject ink through the plurality of nozzles; and
measuring a driving current flowing through a load resistor located between a power supply and the printhead with respect to the plurality of sequentially driven nozzle driving parts.

17. The driving current measurement method as claimed in claim 16, further comprising:
converting the driving current as measured, and a voltage drop at the load resistor into digital signals; and
recognizing characteristics of heating resistances of the printhead based on the digital signals as converted.

18. The driving current measurement method usable with a printhead as claimed in claim 17, wherein the converting of the digital signals uses at least one clock having a frequency of approximately 5 to 10 MHz.

19. A printhead inspection device comprising:
a plurality of nozzle driving parts to drive respective nozzles to eject ink, each of the nozzle driving parts having at least one transistor that is driven by a current supplied by respective nozzle driving signals; and
a nozzle decode/address logic to receive the nozzle driving signals and provide the nozzle driving signals to the respective nozzle driving parts to sequentially drive the nozzle driving parts, wherein the nozzle driving signals are based on one or more representative values that correspond to heating resistance characteristics of the printhead.

20. The printhead inspection device as claimed in claim 19, wherein the representative values are based on one or more driving currents supplied to the nozzle driving parts, and the nozzle driving signals include a driving voltage or a driving pulse width of the printhead determined by use of a pre-stored look up table (LUT) used to compare the representative values to corresponding driving voltage or driving pulse width information stored in the LUT.

21. A printhead driving current measuring device comprising:
a plurality of nozzle driving parts to drive respective nozzles to eject ink, each of the nozzle driving parts having at least one transistor that is driven by a current supplied by respective nozzle driving signals;
a control part to measure driving currents of the corresponding nozzle driving signals supplied to the respective nozzle driving parts; and
a nozzle decode/address logic to receive the nozzle driving signals and provide the nozzle driving signals to the respective nozzle driving parts to sequentially drive the nozzle driving parts, wherein the nozzle driving signals are based on one or more representative values that correspond to heating resistance characteristics of the printhead.

22. A printhead inspection device comprising:
a current measuring part that measures driving currents at a load resistor between a power supply and a plurality of nozzle driving parts of a printhead;
an AD converter that converts the driving currents and the corresponding voltage drop at the load resistor into digital signals;
a calculation part to calculate voltages to be applied to the printhead based on the digital signals and to calculate one or more representative values based on the driving currents and in consideration of an ink ejection velocity; and
a driving control part to generate signals to sequentially drive the plurality of nozzle driving parts and to determine a driving voltage or driving pulse width of the printhead based on the representative values calculated by the calculation part.

23. The printhead inspection device as claimed in claim 22, wherein the calculation part calculates a critical value based on the ejection velocity and a corresponding threshold current value as the representative values.

24. The printhead inspection device as claimed in claim 22, wherein the current measurement part, the AD converter, the calculation part, and the driving control part are embodied in one printhead chip.
